(19) United States
(12) Patent Application Publication
(10) Pub. No.: US 2024/0217133 A1
(43) Pub. Date: Jul. 4, 2024

(54) Cheese Slicing Tool

(71) Applicant: KITCHENDAO KITCHENWARE CO., LTD, Yangjiang (CN)

(72) Inventors: Haisheng CHEN, Yangjiang (CN); Jing HUANG, Yangjiang (CN); Hongzhi LIANG, Yangjiang (CN)

(21) Appl. No.: 18/210,096

(22) Filed: Jun. 15, 2023

(30) Foreign Application Priority Data
Dec. 28, 2022 (CN) 202223598559.8

(51) Int. Cl. B26B 27/00

(52) U.S. Cl. CPC B26B 27/002

(57) ABSTRACT

Some embodiments of the present disclosure provide a cheese slicing tool, which includes a hand-held part and a slicing part connected to each other, wherein a slicing part includes a support frame, a roller assembly, a slicing wire assembly and a first locking assembly, wherein the roller assembly and the slicing wire assembly are both provided on the support frame, the roller assembly is movably connected with the support frame, the slicing wire assembly is located at a front end of the roller assembly, a gap is provided between the slicing wire assembly and the roller assembly, the slicing wire assembly is provided across both ends of the support frame and a part of the slicing wire assembly is embedded into the support frame.

### CROSS-REFERENCE TO RELATED APPLICATIONS

The present disclosure claims priority Chinese Patent Application No. 202223598559.8, filed on Dec. 28 2022 and entitled “Cheese Slicing Tool”.

### TECHNICAL FIELD

The present disclosure relates to a technical field of kitchen tools, and more particularly to a cheese slicing tool.

### BACKGROUND

A cheese slicer belongs to a cutting tool configured to chop a cheese cube into slices. At present, most cheese slicing machines on the market cannot replace a slicing wire, and the service life of the wire is limited. After the wire is broken, the whole cheese slicing machine is directly scrapped. There is also a cheese scrapper on the market, which mainly matches a metal scrapping wire, a roller and a main body for fixing the metal scrapping wire and the roller on the main body, and in use, the cheese cube is sliced into pieces by a gap formed between the metal scrapping wire and the roller. However, when a problem occurs in the metal scrapping wire, for example, the scrapping wire is irreversibly elongated under stress, the scraping wire cannot be further tightened, thereby making the cheese scrapper very difficult to use.

### SUMMARY

An object of the present disclosure is to overcome the problem that the cheese slicing tool known to inventors cannot replace a slicing wire or the slicing wire cannot be continuously tightened after being irreversibly elongated under stress, and to provide a cheese slicing tool that can be tightened after being elongated or loosened by the slicing wire, so as to restore a slicing function, or can be easily disassembled and replaced after the slicing wire is broken or damaged.

In order to achieve the above-mentioned object, the technical solution adopted by the present disclosure is as follows.

The cheese slicing tool includes a hand-held part and a slicing part connected to each other. The slicing part includes a support frame, a roller assembly, a slicing wire assembly and a first locking assembly. The roller assembly and the slicing wire assembly are both provided on the support frame, the roller assembly is movably connected with the support frame, the slicing wire assembly is located at a front end of the roller assembly, a gap is provided between the slicing wire assembly and the roller assembly, the slicing wire assembly is provided across both ends of the support frame and a part of the slicing wire assembly is embedded into the support frame, a first end of the slicing wire assembly is clamped to the support frame and a second end of the slicing wire assembly is clamped to the first locking assembly, and the first locking assembly is inserted into the support frame.

In the above-mentioned solution, by means of inserting the first locking assembly into the support frame, and adjusting the tightness of the slicing wire assembly by using the change of the relative insertion positions of the first locking assembly and the support frame, the slicing wire assembly with two ends embedded into the support frame is always kept tight, so as to achieve a cheese slicing function. In some embodiments, the gap between the slicing wire assembly and the roller assembly is a thickness of a cheese slice, the hand-held part is held and then the roller assembly of the slicing part is abutted against and is pressed on a cheese cube, so that the slicing wire assembly is in contact with an end of the cheese cube and performs cutting by rotating the roller assembly, and the hand-held part is dragged to roll the roller assembly over the entire cheese cube, so as to complete cutting of one cheese slice.

In some embodiments, the first locking assembly includes a first member and a second member. The first member is clamped with the slicing wire assembly, the first member and the second member are respectively inserted into the support frame from both sides of the support frame, and the first member is in threaded connection with the second member. The first locking assembly is installed by directly or indirectly inserting the first member and the second member into the support frame, and is fixed by using a threaded connection between the first member and the second member, and at the same time, the first member is clamped with the slicing wire assembly, so that the slicing wire assembly is fixed during the fixing of the first locking assembly. By using the threaded connection between the second member and the first member, an insertion position of the first member relative to the support frame is changed to adjust the tightness of the slicing wire assembly, so that a part of the slicing wire assembly located in a middle of the support frame is always in a tight state to facilitate the cheese cutting.

In some embodiments, each of both ends of the support frame is provided with a connecting cylinder, a cavity is provided in the connecting cylinder, and the cavity includes a first cavity and a second cavity communicating with each other. An end, far away from the slicing wire assembly, of the first member is provided with an internal thread, the second member is provided with an external thread, the first member is inserted into the first cavity of the connecting cylinder from an end, close to the slicing wire assembly, of the connecting cylinder to be inserted into the connecting cylinder, and the second member is in threaded connection with the first member through the external thread and the internal thread after being inserted into the second cavity of the connecting cylinder from an end, far away from the slicing wire assembly, of the connecting cylinder. The first cavity is provided to facilitate the insertion of the first member and facilitate the threaded connection between the second member and the first member after the second member is inserted into the second cavity of the connecting cylinder.

In some embodiments, a shape of the first cavity is adapted to an outer shape of the first member, and cross-sections of the first cavity and the first member are triangular or polygonal. By means of providing a shape of the first cavity, the first cavity is adapted to the outer shape of the first member, and after the first member is inserted into the connecting cylinder, the first member and the connecting cylinder cannot rotate relatively, so that during the threaded connection between the second member and the first member, an insertion depth of the first member in the connecting cylinder can be adjusted through the depth of the threaded connection. In fact, the longer the depth of the threaded connection between the second member and the first member, the greater the insertion depth of the first member in the connecting cylinder is, and then the slicing wire assembly is pulled down to change from a loosened state to a tight state. The cross-section of the first cavity and the first member is triangular or polygonal, such as quadrilateral, pentagonal, hexagonal, etc., which avoids the first member and the connecting cylinder from rotating relatively after insertion under stress. Of course, the first cavity is cylindrical, and the outer shape of the first member is adapted to the first cavity. A limiting protrusion or a limiting groove is provided in the first cavity so as to limit a rotation between the first cavity and the first member, and within the scope of cognition of those skilled in the art, the shape of the first cavity and the shape of the first member are not limited to the above-mentioned range, but can also be configured for other shapes, as long as it is ensured that the first member is not rotate relative to the connecting cylinder during the threaded connection between the second member and the first member after insertion.

In some embodiments, the slicing wire assembly includes a slicing wire and two buckles. The two buckles are respectively provided at both ends of the slicing wire, one of the two buckles is clamped with an end of the support frame, and the other one of the two buckles is clamped with the first member. The slicing wire is configured to achieve cheese cutting, and in some embodiments, the slicing wire is made of a metal material so as to improve the strength and hardness of the slicing wire during cutting, facilitate the cutting, and prolong the service life of the slicing wire. The buckles are configured to enable the slicing wire to be clamped to the support frame or the first member. Specifically, by means of clamping one of the two buckles to the end, far away from the first member, of the support frame, and clamping the other one of the two buckles to the first member to achieve the connection of the slicing wire assembly, the adjustment of the position of the first member relative to the support frame can achieve the adjustment of the position of the wire slicing assembly relative to the support frame.

In some embodiments, a top of the support frame is provided with a first threading groove, an end, far away from the first locking assembly, of the support frame is provided with a first blind hole, a side of the first member is provided with a second blind hole, a top of the first member is provided with a second threading groove, both ends of the slicing wire is respectively inserted into the first threading groove and the second threading groove, and the two buckles are respectively clamped to the first blind hole and the second blind hole. The first threading groove and the second threading groove are both configured to limit the slicing wire, and the slicing wire and the support frame are installed by means of inserting the slicing wire into the first threading groove and clamping one of the two buckles at an end of the slicing wire to the first blind hole. By means of inserting the slicing wire into the second threading groove, the slicing wire is limited and fixed on the first member, and then the other one of the two buckles is clamped into the second blind hole, so that the connection between the slicing wire assembly and the first member are performed.

In some embodiments, the cheese slicing tool further includes two second locking assemblies. Both ends of the support frame are respectively provided with a chute, the roller assembly include a roller, two ends of the roller are respectively slidably connected with two chutes on two ends of the support frame, and the two second locking assemblies are respectively inserted into the two chutes from both ends of the support frame for locking and fixing the roller assembly. The roller is slidably connected with the chutes, and by means of adjusting the positions of the roller in the chutes, the gap between the roller assembly and the slicing wire is adjusted, thereby changing the thickness of cheese cutting. The second locking assemblies are configured to fasten the roller assembly after the position of the roller assembly relative to the chutes is adjusted, so that the gap between the roller assembly and the slicing wire is maintained, and therefore a fixed thickness is provided during cheese slicing.

In some embodiments, the roller assembly includes a rotating shaft. The roller is sleeved on the rotating shaft, both ends of the rotating shaft are respectively slidably connected with the two chutes, and the second locking assemblies is inserted into or abutted against the rotating shaft for locking. The roller is configured for positioning, and is abutted against the top of the cheese cube during cheese slicing. The rotating shaft has two functions, on the one hand, the roller is rotated relative to the support frame so as to facilitate the cheese cutting; and on the other hand, the rotating shaft is slidably connected with the support frame to adjust the gap between the roller and the slicing wire, so as to adjust the thickness of the cheese slice.

In some embodiments, both ends of the rotating shaft are provided with milling flats, the milling flats is provided with a threaded holes, an end of each of the two second locking assemblies is provided with an external thread, and each of the two second locking assemblies is in threaded connection with the rotating shaft through the external thread of each of the two second locking assemblies and a corresponding threaded hole of a corresponding milling flat after passing through the support frame. The milling flats are provided to facilitate the locking and fixing of the second locking assemblies on the rotating shaft, prevent the position movement after locking and improve the locking reliability. The second locking assemblies are in threaded connection with the rotating shaft and abutted against the support frame, so that the locking and fixing of the rotating shaft is achieved.

In some embodiments, each of the two second locking assemblies includes a screw and a nut. Both ends of the rotating shaft are provided with through holes, and the screw is in threaded connection with the nut after passing through the support frame and a corresponding through hole of the rotating shaft. The screw is in threaded connection with the nut after passing through the support frame and the rotating shaft, so that the locking and fixing of the position of the rotating shaft is achieved.

The beneficial effects of the present disclosure are as follows.

1. By means of clamping the slicing wire assembly to the support frame and to the first locking assembly, the slicing wire assembly is easily and quickly disassembled and replaced.

2. When the slicing wire assembly is irreversibly elongated under stress, the positions of the slicing wire assembly and the support frame are adjusted by adjusting the insertion depth of the first member in the connecting cylinder of the support frame, so that the slicing wire assembly is continuously tightened.

3. A distance between the roller and the slicing wire is adjusted by means of the sliding connection between the rotating shaft and the support frame, so as to achieve the adjustment of the thickness of the cheese slice, and then the second locking assemblies are configured for locking and fixing after the distance is adjusted.

### BRIEF DESCRIPTION OF THE DRAWINGS

FIG. 1 illustrates a schematic structural diagram of a cheese slicing tool according to the present disclosure.

FIG. 2 illustrates a schematic structural diagram of a cheese slicing tool in FIG. 1 after a second locking assembly is disassembled.

FIG. 3 illustrates an exploded structure diagram of a cheese slicing tool according to the present disclosure.

FIG. 4 illustrates a schematic structural diagram of a cheese slicing tool in FIG. 1 after a chute is split.

FIG. 5 illustrates a structural diagram of a cheese slicing tool adjusted to a state where the thickness of a cheese slice is maximum according to the present disclosure.

FIG. 6 illustrates a structural diagram of a cheese slicing tool adjusted to a state where the thickness of a cheese slice is minimum according to the present disclosure.

FIG. 7 illustrates a schematic structural diagram of a slicing assembly of a cheese slicing tool according to the present disclosure.

FIG. 8 illustrates a schematic structural diagram of a rotating shaft of a cheese slicing tool according to the present disclosure.

FIG. 9 illustrates a schematic structural diagram of a first member of a cheese slicing tool according to the present disclosure.

Herein, reference signs are described as follows:

1. Hand-held part; 2. Slicing part; 21. Support frame; 211. Connecting cylinder; 212. First threading groove; 213. Chute; 214. First blind hole; 22. Roller assembly; 221. Roller; 222. Rotating shaft; 2221. Milling flat; 23. Slicing wire assembly; 231. Slicing wire; 232. Buckle; 24. First locking assembly; 241. First member; 2411. Second blind hole; 2412. Second threading groove; 242. Second member; and 25. Second locking assembly.

### DETAILED DESCRIPTION OF THE EMBODIMENTS

The drawings are used for illustrative purposes only and cannot be construed as limiting the present disclosure. In order to better illustrate the embodiment, some parts in the drawings are omitted, enlarged or reduced, and do not represent the actual product size. For those skilled in the art, some well-known structures and descriptions thereof in the drawings may be omitted. The positional relationships described in the drawings are used for illustrative purposes only and cannot be construed as limiting the present disclosure.

The same or similar reference signs in the drawings of the embodiments of the present disclosure correspond to the same or similar parts. In the description of the present disclosure, it is to be understood that if the orientations or positional relationships indicated by the terms “upper”, “down”, “left”, “right”, “long”, “short”, etc. are based on the orientations or positional relationships shown in the drawings, and are only for the convenience of describing the present disclosure and simplifying the description. The description does not indicate or imply that the device or member referred to must have a specific orientation, be constructed and operated in a specific orientation, and therefore the terms describing the positional relationships in the drawings are used for illustrative purposes only and cannot be construed as limiting the present disclosure. The specific meanings of the above-mentioned terms in the present disclosure may be understood by those of ordinary skill in the art in specific circumstances.

The technical solution of the present disclosure will be described in detail below by means of specific embodiments in conjunction with the drawings.

### Embodiment 1

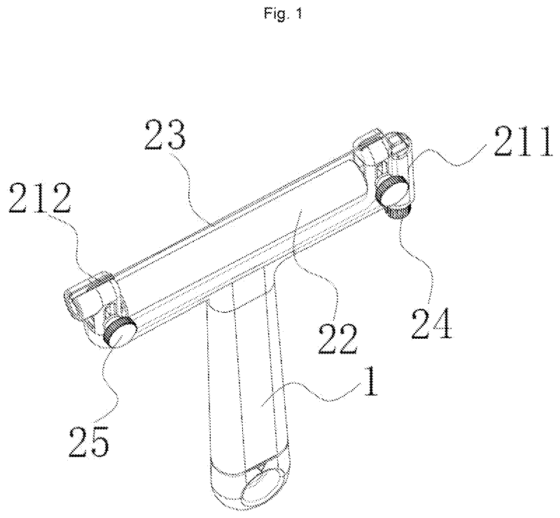

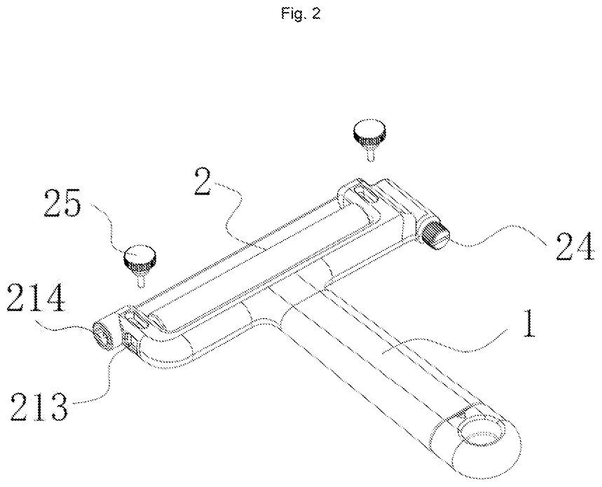

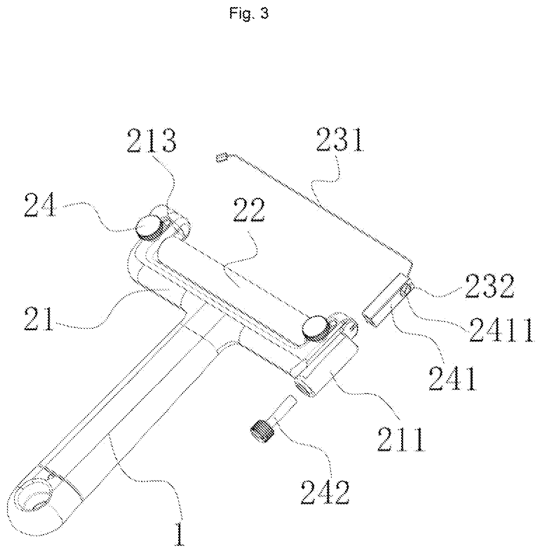

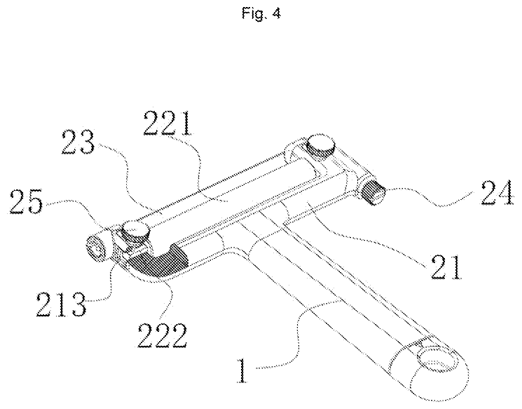

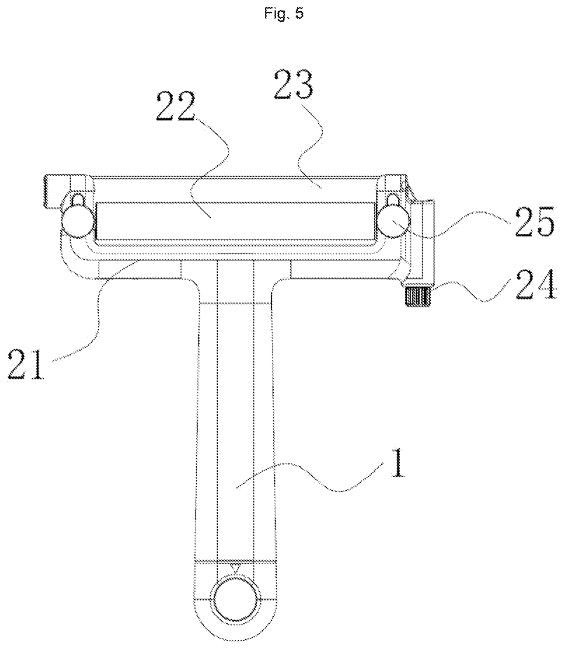

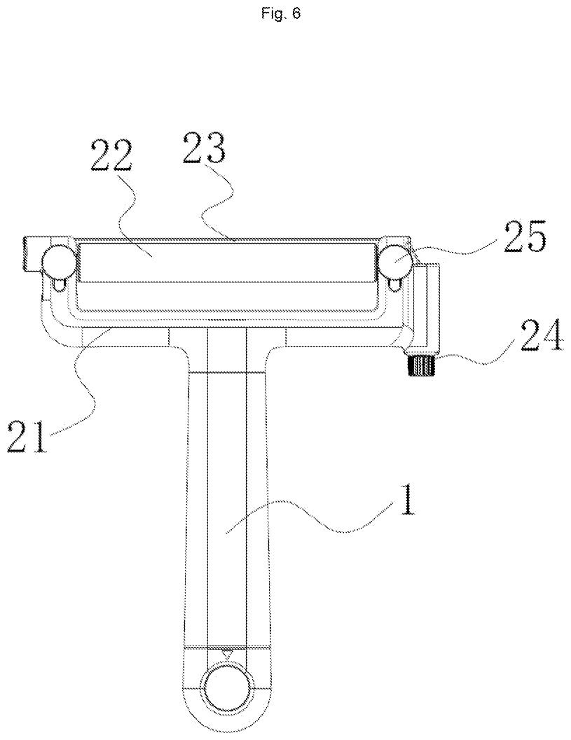

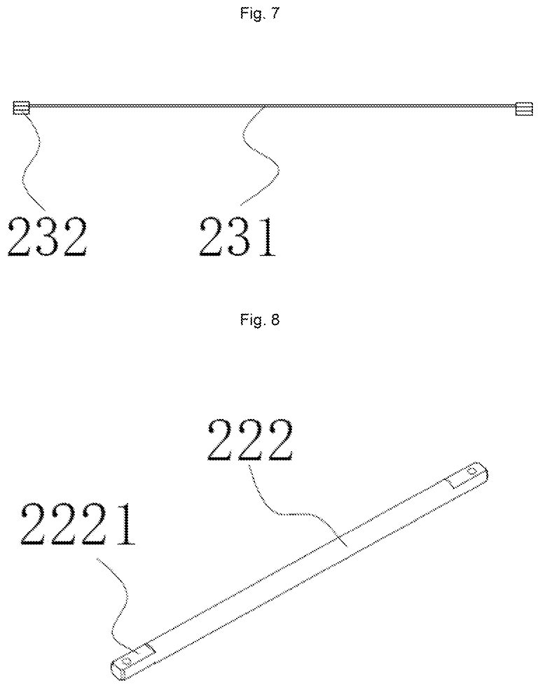

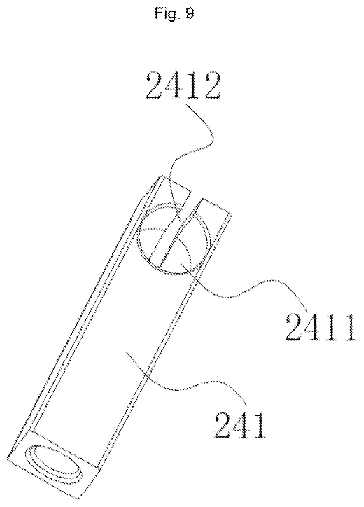

As shown in FIGS. 1 to 9, Embodiment 1 of a cheese slicing tool of the present disclosure includes a hand-held part 1 and a slicing part 2 connected with each other. The hand-held part 1 facilitates holding the cheese slicing tool, and the slicing part 2 is configured for cheese cutting. The slicing part 2 includes a support frame 21, a roller assembly 22, a slicing wire assembly 23 and a first locking assembly 24. The roller assembly 22 and the slicing wire assembly 23 are both provided on the support frame 21. The roller assembly 22 is movably connected with the support frame 21, so that the roller assembly 22 rolls in a process of dragging the hand-held part 1, and therefore the sliding friction becomes the rolling friction, the friction force is reduced, the power is saved, and at the same time, the cheese cutting is facilitated. The slicing wire assembly 23 is located at a front end of the roller assembly 22, a gap is provided between the slicing wire assembly 23 and the roller assembly 22, the gap is a thickness of a cheese slice, and the thickness of the cheese slice is adjusted by adjusting the gap between the slicing wire assembly 23 and the roller assembly 22. The slicing wire assembly 23 is provided across both ends of the support frame 21 and a part of the slicing wire assembly 23 is embedded into the support frame 21 so as to limit the slicing wire assembly 23 and avoid random shaking when the slicing wire assembly 23 performs cheese cutting from affecting the uniformity of the thickness of the slice. A first end of the slicing wire assembly 23 is clamped to the support frame 21 and a second end of the slicing wire assembly 23 is clamped to the first locking assembly 24, and the first locking assembly 24 is inserted into the support frame 21. By means of clamping the first locking assembly 24 with the slicing wire assembly 23, the position of the slicing wire assembly 23 is fastened by the first locking assembly 24. By means of inserting the first locking assembly 24 into the support frame 21, the position between the slicing wire assembly 23 and the support frame 21 is adjusted by adjusting the position of the first locking assembly 24 relative to the support frame 21, so as to achieve the purpose of fastening when the slicing wire assembly 23 is loosened. The first locking assembly 24 includes a first member 241 and a second member 242. The first member 241 is clamped with the slicing wire assembly 23, the first member 241 and the second member 242 are respectively inserted into the support frame 21 from both sides of the support frame 21, and the first member 241 is in threaded connection with the second member 242. The slicing wire assembly 23 is positioned by clamping the first member 241 to the slicing wire assembly 23, then a reliable insertion between the first member 241 and the support frame 21 is achieved through the threaded connection between the second member 242 and the first member 241, and an insertion depth of the first member 241 and the support frame 21 is kept stable. Specifically, each of both ends of the support frame 21 is provided with a connecting cylinder 211, a cavity is provided in the connecting cylinder 211, and the cavity includes a first cavity and a second cavity communicating with each other. An end, far away from the slicing wire assembly 23, of the first member 241 is provided with an internal thread, the second member 242 is provided with an external thread, the first member 241 is inserted into the first cavity of the connecting cylinder 211 from an end, close to the slicing wire assembly 23, of the connecting cylinder 211 to be inserted into the connecting cylinder 211, and the second member 242 is in threaded connection with the first member 241 through the external thread and the internal thread after being inserted into the second cavity of the connecting cylinder 211 from an end, far away from the slicing wire assembly 23, of the connecting cylinder 211. The first member 241 is directly inserted into the connecting cylinder 211, the second member 242 is indirectly inserted into the connecting cylinder 211, and the first member 241 and the second member 242 are respectively inserted from both ends of the connecting cylinder 211, so that when the second member 242 is in threaded connection with the first member 241, the locking and fixing of the first member 241 is performed by using the abutment of the second member 242 against the connecting cylinder 211. In some embodiments, a shape of the first cavity is adapted to an outer shape of the first member 241, and cross-sections of the first cavity and the first member are triangular or polygonal. In this embodiment, the cross-sections of the first cavity and the first member 241 are square. By means of defining the shape of the first cavity and the shape of the first member 241, the situation that the slicing wire assembly 23 is not be tightened due to rotation of the first member 241 relative to the connecting cylinder 211 during the threaded connection between the second member 242 and the first member 241 is avoided.

In some embodiments, the slicing wire assembly 23 includes a slicing wire 231 and two buckles 232. The two buckles 232 are respectively provided at both ends of the slicing wire 231, one of the two buckles 232 is clamped with an end of the support frame 21, and the other one of the two buckles 232 is clamped with the first member 241. Furthermore, a top of the support frame 21 is provided with a first threading groove 212, an end, far away from the first locking assembly 24, of the support frame 21 is provided with a first blind hole 214, a side of the first member 241 is provided with a second blind hole 2411, a top of the first member 241 is provided with a second threading groove 2412, both ends of the slicing wire 231 is respectively inserted into the first threading groove 212 and the second threading groove 2412, and the two buckles 232 are respectively clamped to the first blind hole 214 and the second blind hole 2411. As long as the size each of the two buckles 232 is larger than the first threading groove 212 and the second threading groove 2412, when the slicing wire 231 is under stress, the slicing wire 231 is not be retracted due to the limit of the buckles 232. The two buckles 232 are contained in the first blind hole 214 and the second blind hole 2411 respectively for clamping and limiting.

### Embodiment 2

This embodiment is Embodiment 2 of a cheese slicing tool. This embodiment is similar to Embodiment 1 except that the cheese slicing tool further includes two second locking assemblies 25. Both ends of the support frame 21 are respectively provided with a chute 213, The roller assembly 22 includes a roller 221, two ends of the roller 221 are respectively slidably connected with the two chutes 213 on two ends of the support frame 21, and the two second locking assemblies 25 are respectively inserted into the two chutes 213 from both ends of the support frame 21 for locking and fixing the roller assembly 22. By means of adjusting the positions of the roller 221 in the chutes 213, the gap between the roller 221 and the slicing wire 231 is adjusted, thereby changing the thickness of cheese cutting. The second locking assemblies 25 are configured to fasten the roller assembly 22 after the position of the roller assembly 22 relative to the chutes 213 is adjusted, so that the gap between the roller assembly 22 and the slicing wire 231 is maintained, and therefore a fixed thickness is provided during cheese slicing. The roller assembly 22 includes a rotating shaft 222. The roller 221 is sleeved on the rotating shaft 222, both ends of the rotating shaft 222 are respectively slidably connected with the two chutes 213, and the second locking assemblies 25 is inserted into or abutted against the rotating shaft 222 for locking. The roller 221 is configured for positioning, and is abutted against the top of the cheese cube during cheese slicing. The rotating shaft 222 has two functions, on the one hand, the roller 221 is rotated relative to the support frame 21 so as to facilitate the cheese cutting; and on the other hand, the rotating shaft 222 is slidably connected with the support frame 21 to adjust the gap between the roller 221 and the slicing wire 231, so as to adjust the thickness of the cheese slice.

As an improvement solution of this embodiment, both ends of the rotating shaft 222 are provided with milling flats 2221, each of the milling flats 2221 is provided with a threaded hole, an end of each of the two second locking assemblies 25 is provided with an external thread, and each of the two second locking assemblies 25 is in threaded connection with the rotating shaft 222 through the external thread of each of the two second locking assemblies 25 and a corresponding threaded hole of a corresponding milling flat 2221 after passing through the support frame 21. The milling flats 2221 are provided to facilitate the locking and fixing of the second locking assemblies 25 on the rotating shaft 222, prevent the position movement after locking and improve the locking reliability. The second locking assemblies 25 are in threaded connection with the rotating shaft 222 and abutted against the support frame 21, so that the locking and fixing of the rotating shaft 222 is achieved.

### Embodiment 3

This embodiment is Embodiment 3 of a cheese slicing tool. This embodiment is similar to Embodiment 2 except that each of two second locking assemblies 25 includes a screw and a nut. Both ends of the rotating shaft 222 are provided with through holes, and the screw is in threaded connection with the nut after passing through the support frame 21 and a corresponding through hole of the rotating shaft 222. The screw is in threaded connection with the nut after passing through the support frame 21 and the rotating shaft 222, so that the locking and fixing of the position of the rotating shaft 222 is achieved.

It is apparent that the above-mentioned embodiments of the present disclosure are only examples for clearly illustrating the present disclosure and are not intended to limit the implementation modes of the present disclosure. Other variations or modifications in various forms may be made by those of ordinary skill in the art based on the above description. There is no need and no way to exhaust all of the implementation modes. Any modifications, equivalent substitutions, improvements, etc. within the spirit and scope of the present disclosure shall be included in the scope of protection of the present disclosure.

What is claimed is:

1. A cheese slicing tool, comprising a hand-held part and a slicing part connected with each other, wherein the slicing part comprises a support frame, a roller assembly, a slicing wire assembly and a first locking assembly, wherein the roller assembly and the slicing wire assembly are both provided on the support frame, the roller assembly is movably connected with the support frame, the slicing wire assembly is located at a front end of the roller assembly, a gap is provided between the slicing wire assembly and the roller assembly, the slicing wire assembly is provided across both ends of the support frame, and a part of the slicing wire assembly is embedded into the support frame, a first end of the slicing wire assembly is clamped to the support frame and a second end of the slicing wire assembly is clamped to the first locking assembly, and the first locking assembly is inserted into the support frame.

2. The cheese slicing tool as claimed in claim 1, wherein the first locking assembly comprises a first member and a second member, wherein the first member is clamped with the slicing wire assembly, the first member and the second member are respectively inserted into the support frame from both sides of the support frame, and the first member is in threaded connection with the second member.

3. The cheese slicing tool as claimed in claim 2, wherein each of both ends of the support frame is provided with a connecting cylinder, a cavity is provided in the connecting cylinder, and the cavity comprises a first cavity and a second cavity communicating with each other; an end, far away from the slicing wire assembly, of the first member is provided with an internal thread, the second member is provided with an external thread, the first member is inserted into the first cavity of the connecting cylinder from an end, close to the slicing wire assembly, of the connecting cylinder to be inserted into the connecting cylinder, and the second member is in threaded connection with the first member through the external thread and the internal thread after being inserted into the second cavity of the connecting cylinder from an end, far away from the slicing wire assembly, of the connecting cylinder.

4. The cheese slicing tool as claimed in claim 3, wherein a shape of the first cavity is adapted to an outer shape of the first member, and cross-sections of the first cavity and the first member are triangular or polygonal.

5. The cheese slicing tool as claimed in claim 2, wherein the slicing wire assembly comprises a slicing wire and two buckles, wherein the two buckles are respectively provided at both ends of the slicing wire, one of the two buckles is clamped with an end of the support frame, and the other one of the two buckles is clamped with the first member.

6. The cheese slicing tool as claimed in claim 5, wherein a top of the support frame is provided with a first threading groove, an end, far away from the first locking assembly, of the support frame is provided with a first blind hole, a side of the first member is provided with a second blind hole, a top of the first member is provided with a second threading groove, both ends of the slicing wire is respectively inserted into the first threading groove and the second threading groove, and the two buckles are respectively clamped to the first blind hole and the second blind hole.

7. The cheese slicing tool as claimed in claim 1, wherein the cheese slicing tool comprises two second locking assemblies, wherein both ends of the support frame are respectively provided with a chute, the roller assembly comprises a roller, wherein two ends of the roller are respectively slidably connected with two chutes on two ends of the support frame, and the two second locking assemblies are respectively inserted into the two chutes from both ends of the support frame for locking and fixing the roller assembly.

8. The cheese slicing tool as claimed in claim 7, wherein the roller assembly comprises a rotating shaft, wherein the roller is sleeved on the rotating shaft, both ends of the rotating shaft are respectively slidably connected with the two chutes, and the second locking assemblies is inserted into or abutted against the rotating shaft for locking.

9. The cheese slicing tool as claimed in claim 8, wherein both ends of the rotating shaft are provided with milling flats, each of the milling flats is provided with a threaded hole, an end of each of the two second locking assemblies is provided with an external thread, and each of the two second locking assemblies is in threaded connection with the rotating shaft through the external thread of each of the two second locking assemblies and a corresponding threaded hole of a corresponding milling flat after passing through the support frame.

10. The cheese slicing tool as claimed in claim 8, wherein each of the two second locking assemblies comprises a screw and a nut, wherein both ends of the rotating shaft are provided with through holes, and the screw is in threaded connection with the nut after passing through the support frame and a corresponding through hole of the rotating shaft.

11. The cheese slicing tool as claimed in claim 3, wherein the slicing wire assembly comprises a slicing wire and two buckles, wherein the two buckles are respectively provided at both ends of the slicing wire, one of the two buckles is clamped with an end of the support frame, and the other one of the two buckles is clamped with the first member.

12. The cheese slicing tool as claimed in claim 4, wherein the slicing wire assembly comprises a slicing wire and two buckles, wherein the two buckles are respectively provided at both ends of the slicing wire, one of the two buckles is clamped with an end of the support frame, and the other one of the two buckles is clamped with the first member.

13. The cheese slicing tool as claimed in claim 3, wherein the second member is in threaded connection with the first member, and the second member is abutted against the connecting cylinder.

14. The cheese slicing tool as claimed in claim 4, wherein the cross-sections of the first cavity and the first member are square.
